(19) United States
(12) Patent Application Publication
(10) Pub. No.: US 2026/0146694 A1
(43) Pub. Date: May 28, 2026

(54) COUPLING DEVICE

(71) Applicant: Surpass Industry Co., Ltd., Gyoda-shi (JP)

(72) Inventors: Masahiro HASUNUMA, Gyoda-shi (JP); Masamichi KOBAYASHI, Gyoda-shi (JP)

(73) Assignee: Surpass Industry Co., Ltd., Gyoda-shi (JP)

(21) Appl. No.: 19/391,951

(22) Filed: Nov. 17, 2025

(30) Foreign Application Priority Data
Nov. 22, 2024 (JP) 2024-203812

(51) Int. Cl. F16L 35/00; F16L 33/00

(52) U.S. Cl. CPC F16L 35/00; F16L 33/00

(57) ABSTRACT

A coupling device includes: a cylindrical housing part where a plug device is inserted in one end side and a supply pipe is connected to the other end side; a valve part that, by contact with the plug device inserted in the housing part, forms an open state where a liquid flows into the coupling device from the plug device; a bellows part having an expandable internal flow channel formed therein through which the liquid flowing in from the plug device is supplied to the supply pipe in the open state; and a stopper forming a supply flow channel through which the liquid is supplied from the internal flow channel to the supply pipe. The stopper is formed of a conductive fluororesin material containing a fluororesin material and a conductive material dispersed in the fluororesin material and is in electrical conduction with a grounding part maintained at a ground potential.

### CROSS-REFERENCE TO RELATED APPLICATIONS

This application claims foreign priority benefits under U.S.C. §119 to Japanese Patent Application No. 2024-203812 filed on November 22, 2024, the contents of which is hereby incorporated by reference in its entirety.

### BACKGROUND

### 1. TECHNICAL FIELD

The present disclosure relates to a coupling device.

### 2. DESCRIPTION OF RELATED ART

Fluororesin materials have excellent chemical resistance and contamination resistance and thus have been widely used in fluid devices that circulate a liquid such as corrosive pure water used in manufacturing of semiconductors. However, fluororesin materials have a volume resistivity larger than 10¹⁸ Ω∙cm and are categorized into insulating materials in general. Thus, electrostatic charge due to friction between a fluid and a fluid flow channel formed inside a fluid device may occur inside the fluid device made of a fluororesin material.

To address the above problem, an antistatic fluororesin tube is known in which conductive portions made of a fluororesin composition containing a conductive substance are embedded in a striped pattern in the outer circumferential face to provide conductivity (see, for example, Japanese Patent Application Laid-Open No. 2003-4176).

In the antistatic fluororesin tube disclosed in Japanese Patent Application Laid-Open No. 2003-4176, however, no conductivity is provided to the inner circumferential face of a fluid flow channel where electrostatic charge is likely to occur due to friction with a fluid.

Thus, it is not possible to reliably remove electrostatic charge occurring on the inner circumferential face of the fluid flow channel, and a resin material forming the fluid flow channel may have dielectric breakdown due to excessive electrostatic charge of static electricity. In particular, in a fluid device having a bellows part with an expandable internal flow channel formed therein, there is a problem that the expandable portion having a smaller thickness than the remaining portion is particularly likely to have dielectric breakdown.

### SUMMARY

The present disclosure has been made in view of such circumstances and intends to provide a coupling device that can suitably protect a bellows part having an expandable internal flow channel formed therein from having dielectric breakdown.

The present disclosure employs the following solutions in order to achieve the object described above.

The coupling device according to the present disclosure is a coupling device for coupling a plug device and a supply pipe to each other, the plug device being for supplying a liquid, and the supply pipe being for supplying the liquid to a supply target, the coupling device includes: a cylindrical housing part, the plug device being inserted in one end side of the housing part, and the supply pipe being connected to the other end side of the housing part; a valve part configured to, due to contact with the plug device inserted in the housing part, be in an open state where the liquid flows into the coupling device from the plug device; a bellows part having an expandable internal flow channel formed in the bellows part, the liquid flowing in from the plug device being supplied to the supply pipe through the expandable internal flow channel when the valve part is in the open state; and a flow channel part forming a supply flow channel, the liquid being supplied from the internal flow channel to the supply pipe through the supply flow channel, and one of the bellows part and the flow channel part is formed of a conductive fluororesin material, the conductive fluororesin material containing a fluororesin material and a conductive material dispersed in the fluororesin material, and is in electrical conduction with a grounding part maintained at a ground potential.

According to the coupling device of the present disclosure, when the plug device has been inserted in one end side of the housing part, the valve part is opened, and a liquid flows into the coupling device. The liquid that has flown into the housing part is supplied from the bellows part having the expandable internal flow channel formed therein to the supply pipe connected to the other end side of the housing part via the supply flow channel defined by the flow channel part.

When the liquid flows through the coupling device from the plug device to the supply pipe, electrostatic charge may occur on the bellows part or a member nearby due to friction between the internal flow channel and the liquid. In particular, when the liquid supplied from the plug device to the coupling device is in a form of a mist mixed with air, occurrence of electrostatic charge on the bellows part or a member nearby is notable. Further, when the flow channel sectional area of the flow channel through which a liquid flows at the bellows part or a part nearby is smaller than that of the upstream flow channel, the flow velocity of the liquid at the bellows part or a part nearby is higher, and the occurrence of electrostatic charge at the bellows part or the member downstream thereof is notable.

According to the coupling device of the present disclosure, one of the bellows part and the flow channel part is formed of a conductive fluororesin material and is in electrical conduction with the grounding part maintained at the ground potential. Thus, the static electricity charged on the bellows part or the member nearby is removed by the grounding part via one of the bellows part and the flow channel part formed of the conductive fluororesin material. In such a way, according to the coupling device of the present disclosure, it is possible to suitably protect a bellows part having an expandable internal flow channel formed therein from having dielectric breakdown.

The coupling device according to the present disclosure may be configured such that the flow channel part is formed of the conductive fluororesin material and is in electrical conduction with the grounding part.

According to the coupling device of the present configuration, the flow channel part arranged downstream in the liquid flow direction from the bellows part is caused to have electrical conduction with the grounding part, and thereby static electricity charged on the bellows part or the member nearby can be removed by the grounding part via the flow channel part formed of the conductive fluororesin material.

The coupling device of the above configuration may be formed such that the flow channel part is formed in a cylindrical shape and fixed to an inner circumferential face of the housing part, the housing part has a through hole passing through between the inner circumferential face and an outer circumferential face of the housing part toward the flow channel part, and the grounding part has a conductive member inserted in the through hole and arranged in contact with the flow channel part.

According to the coupling device of the present form, the conductive member is inserted in the through hole of the housing part to be in contact with the flow channel part, thereby the flow channel part is caused to have electrical conduction with the grounding part, and static electricity charged on the bellows part or the member nearby can be suitably removed.

The coupling device of the above configuration may be formed such that the flow channel part is a plate-like member formed in a circular annular shape so as to surround an axis along which the supply flow channel extends.

According to the coupling device of the present form, the inner circumferential side of the plate-like member formed in a circular annular shape is a part of the supply flow channel, and thereby static electricity charged on the liquid flowing through the supply flow channel or the member nearby can be suitably removed via the grounding part.

The coupling device according to the present disclosure may be configured such that the bellows part is formed of the conductive fluororesin material and is in electrical conduction with the grounding part.

According to the coupling device of the present configuration, the bellows part is caused to have electrical conduction with the grounding part, and thereby static electricity charged on the bellows part or the member nearby can be removed by the grounding part via the flow channel part formed of the conductive fluororesin material.

The coupling device of the above configuration may be formed such that the housing part has a through hole passing through between the inner circumferential face and an outer circumferential face of the housing part toward the bellows part, and the grounding part has a conductive member inserted in the through hole and arranged in contact with the bellows part.

According to the coupling device of the present form, the conductive member is inserted in the through hole of the housing part to come into contact with the bellows part, thereby the bellows part is caused to have electrical conduction with the grounding part, and static electricity charged on the bellows part or the member nearby can be suitably removed.

According to the present disclosure, it is possible to provide a coupling device that can suitably protect a bellows part having an expandable internal flow channel formed therein from having dielectric breakdown.

### BRIEF DESCRIPTION OF THE DRAWINGS

FIG. 1 is a partial longitudinal sectional view illustrating a liquid supply system according to a first embodiment of the present disclosure.

FIG. 2 is a partial enlarged view of a part A of the liquid supply system illustrated in FIG. 1, which illustrates a state where a coupling device is mounted on a plug device.

FIG. 3 is a partial enlarged view of the part A of the liquid supply system illustrated in FIG. 1, which illustrates a state where the coupling device is detached from the plug device.

FIG. 4 is a longitudinal sectional view illustrating a modified example of the coupling device illustrated in FIG. 3.

FIG. 5 is a longitudinal sectional view illustrating a coupling device according to a second embodiment of the present disclosure.

FIG. 6 is a partial enlarged view of a part B of the coupling device illustrated in FIG. 5.

FIG. 7 is a longitudinal sectional view illustrating a first modified example of the coupling device illustrated in FIG. 6.

FIG. 8 is a longitudinal sectional view illustrating a second modified example of the coupling device illustrated in FIG. 6.

FIG. 9 is a longitudinal sectional view illustrating a third modified example of the coupling device illustrated in FIG. 6.

FIG. 10 is a longitudinal sectional view illustrating a fourth modified example of the coupling device illustrated in FIG. 6.

### DETAILED DESCRIPTION

### First Embodiment

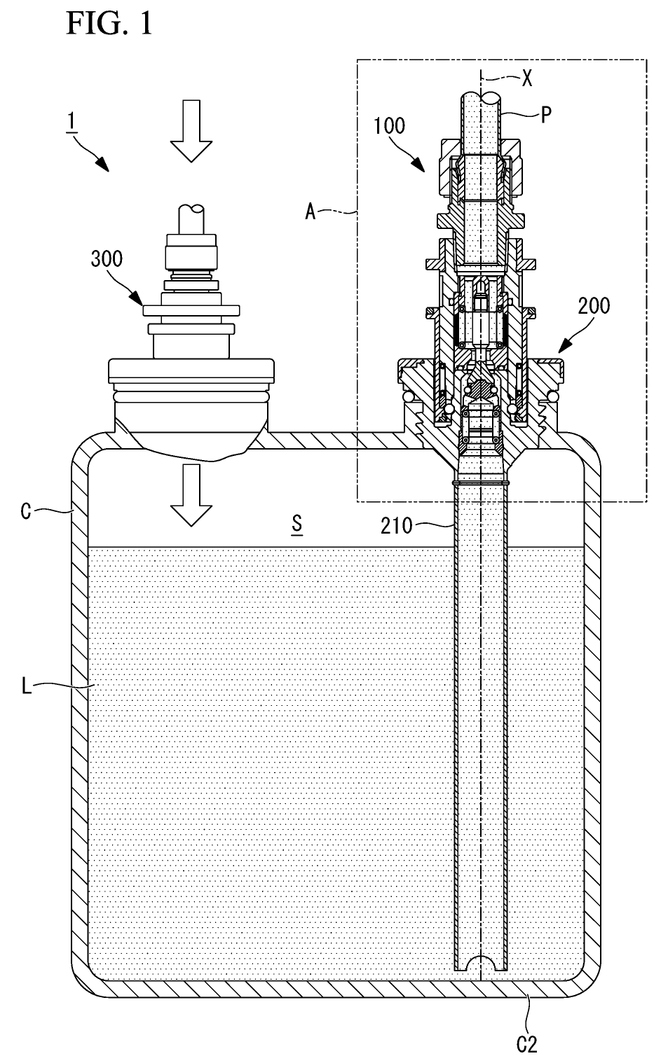

A liquid supply system 1 according to a first embodiment of the present disclosure will be described below with reference to the drawings. FIG. 1 is a partial longitudinal sectional view illustrating the liquid supply system 1 according to the present embodiment. The liquid supply system 1 of the present embodiment illustrated in FIG. 1 is a device that supplies a liquid L stored in a liquid storage container C to a plurality of supply target devices (not illustrated). Herein, the liquid L in the present embodiment may be, for example, pure water or various chemical solutions used in a semiconductor manufacturing process of a semiconductor manufacturing apparatus.

As illustrated in FIG. 1, the liquid supply system 1 has a coupling device 100, a plug device 200, and an air supply device 300. The coupling device 100 is a device that couples the plug device 200, which is attached to the liquid storage container C, and a supply pipe P, which is configured for supplying the liquid L to the supply target device, to each other. The plug device 200 is a device that supplies the liquid L stored in the liquid storage container C to the supply pipe P via the coupling device 100. The air supply device 300 is a device that supplies compressed air to an internal space S of the liquid storage container C in a direction illustrated by the arrow in FIG. 1. The air supply device 300 increases the pressure in the internal space S and thereby supplies the liquid L to the coupling device 100 via the plug device 200.

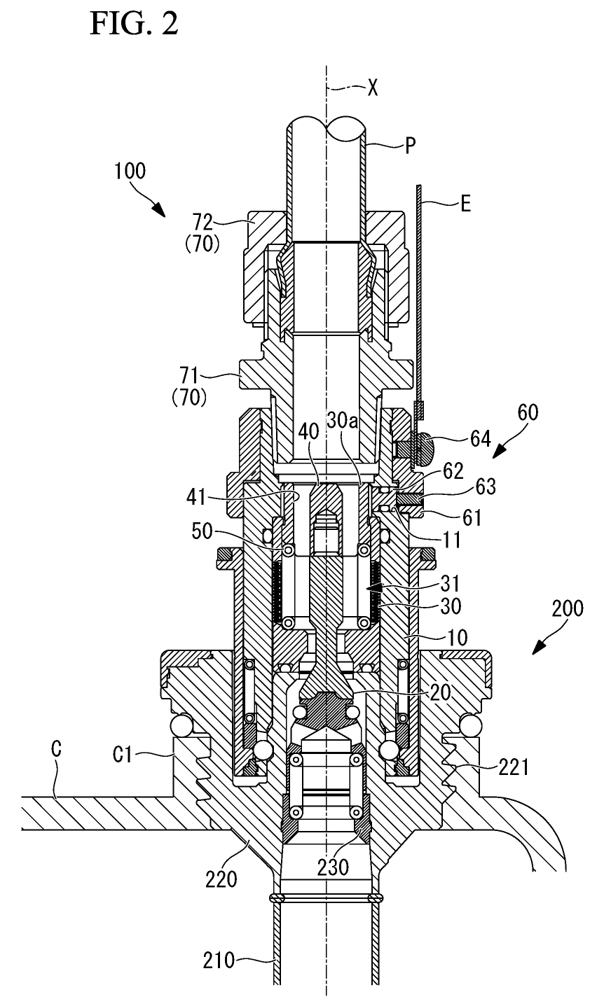

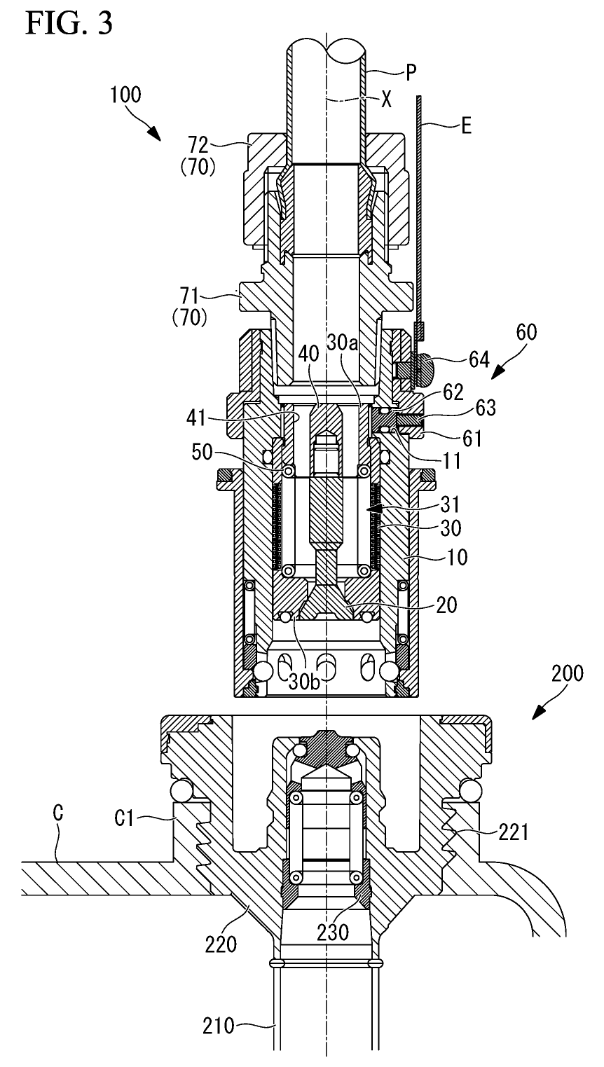

FIG. 2 is a partial enlarged view of the part A of the liquid supply system 1 illustrated in FIG. 1 and illustrates a state where the coupling device 100 is mounted on the plug device 200. FIG. 3 is a partial enlarged view of the part A of the liquid supply system 1 illustrated in FIG. 1 and illustrates a state where the coupling device 100 is detached from the plug device 200.

As illustrated in FIG. 2 and FIG. 3, the plug device 200 has a siphon tube 210 fixed to an opening C1 of the liquid storage container C and extending along an axis X. The axis X is an axis extending in the vertical direction. The siphon tube 210 extends up to a part near a bottom part C2 of the liquid storage container C. An external thread 221 is formed on the outer circumferential face of the body 220 of the plug device 200. When the external thread 221 is engaged with an internal thread of the opening C1, the plug device 200 is fixed to the opening C1.

The coupling device 100 has a housing part 10, a valve part 20, a bellows part 30, a stopper (flow channel part) 40, a spring 50, a grounding part 60, and a pipe connecting part 70. The stopper 40 is formed of a conductive fluororesin material containing a fluororesin material and a conductive material dispersed in the fluororesin material. The housing part 10, the valve part 20, the bellows part 30, the spring 50, and the pipe connecting part 70 are formed of a nonconductive fluororesin material in which no conductive material is dispersed.

Herein, the fluororesin material may be, for example, polytetrafluoroethylene (PTFE), polychlorotrifluoroethylene (PCTFE), or tetrafluoroethylene-perfluoroalkyl vinyl ether copolymer (PFA). As the fluororesin material, a powdery material (for example, PTEE G163 by AGC Inc.) can be used.

Further, the conductive fluororesin material used in the present embodiment is a material containing a fluororesin material and carbon nanotubes dispersed in the fluororesin material. As the carbon nanotube dispersed in the fluororesin material, for example, it is desirable to use those having the following properties:

having a fiber length of 50 μm or greater and 150 μm or less;

having a fiber diameter of 5 nm or greater and 20 nm or less;

having a bulk density of 10 mg/cm³ or greater and 70mg/cm³ or less;

having a G/D ratio of 0.7 or greater and 2.0 or less;

having a purity of 99.5% or greater; and/or

formed in multiple layers (for example, 4 to 12 layers).

Herein, the reason for the fiber length of the carbon nanotube being desirably 50 μm or greater is to provide sufficient conductivity with a small quantity of carbon nanotubes when the carbon nanotubes are dispersed in the fluororesin material.

Further, in the conductive fluororesin material used in the present embodiment, the addition amount of carbon nanotubes is in a range of 0.020% by weight or greater and 0.030% by weight or less. Accordingly, the volume resistivity of the conductive fluororesin material is greater than 1.0 x 10³ Ω∙cm and less than 1.0 x 10⁴ Ω∙cm.

The housing part 10 is a cylindrical member in which the plug device 200 is inserted in one end side and the supply pipe P is connected to the other end side. The housing part 10 has a through hole 11 passing through between the inner circumferential face and the outer circumferential face thereof toward the stopper 40.

As illustrated in FIG. 2, the valve part 20 is a device that, when the plug device 200 has been inserted in the housing part 10, is in an open state where the liquid L flows into the coupling device 100 from the plug device 200 due to contact with a valve part 230 of the plug device 200. As illustrated in FIG. 3, when the plug device 200 is not inserted in the housing part 10, the valve part 20 is in a closed state where the liquid L does not flow into the coupling device 100 from the plug device 200.

The bellows part 30 is a member having an expandable internal flow channel 31 formed therein through which the liquid L flowing in from the plug device 200 is supplied to the supply pipe P when the valve part 20 is in the open state. The flow channel sectional area of the internal flow channel 31 is smaller than the flow channel sectional area of the upstream flow channel of the internal flow channel 31 defined by the siphon tube 210. Thus, electrostatic charge is likely to occur on the bellows part 30 or the stopper 40 arranged downstream thereof.

The stopper 40 is a member that fixes the top end 30a of the bellows part 30 to the housing part 10. The stopper 40 is formed in a cylindrical shape and fixed to the inner circumferential face of the housing part 10. The stopper 40 forms a plurality of supply flow channels 41 through which a liquid is supplied from the internal flow channel 31 of the bellows part 30 to the supply pipe P.

The spring 50 is a member that provides pushing force so as to maintain a state where the end 30b of the bellows part 30 is in contact with the valve part 20 and the bellows part 30 is expanded when the plug device 200 is not inserted in the housing part 10.

The grounding part 60 is a member arranged to have electrical conduction with the stopper 40, coupled to the grounding cable E, and thereby maintained at a ground potential. The grounding part 60 has a body 61, a pin member (conductive member) 62, a fixing screw 63, and an attaching screw 64 formed of conductive materials (for example, a stainless-steel material), respectively.

The body 61 is a member formed in a circular cylindrical shape so as to surround the top end of the housing part 10. An internal thread into which the fixing screw 63 is fastened and an internal thread into which the attaching screw 64 is fastened are formed to the body 61. The pin member 62 is inserted in the through hole 11 of the housing part 10. The pin member 62 is arranged in contact with the stopper 40 by being pushed against the outer circumferential face of the stopper 40 by the tip of the fixing screw 63.

The pipe connecting part 70 has a body 71 fastened to the inner circumferential face of the top end of the housing part 10 and a fastening nut 72 used for fixing the supply pipe P to the top end of the body 71. The pipe connecting part 70 fastens the fastening nut 72 having the supply pipe P inserted therein to the body 71 and thereby fixes the supply pipe P between the fastening nut 72 and the body 71.

The effects and advantages achieved by the coupling device 100 of the present embodiment described above will be described.

According to the coupling device 100 of the present embodiment, when the plug device 200 is inserted in one end side of the housing part 10, the valve part 20 is in an open state, and a liquid flows into the coupling device 100. The liquid that has flown into the housing part 10 is supplied from the bellows part 30, which has the expandable internal flow channel 31 formed therein, to the supply pipe P, which is connected to the other end side of the housing part 10, via the supply flow channel 41 defined by the stopper 40.

When the liquid L flows from the plug device 200 to the supply pipe P via the coupling device 100, electrostatic charge may occur on the bellows part 30 or the member nearby such as the stopper 40 due to friction between the internal flow channel 31 and the liquid L. In particular, when the liquid supplied from the plug device 200 to the coupling device 100 is in a form of a mist mixed with air, occurrence of electrostatic charge on the bellows part 30 or the member nearby such as the stopper 40 is notable. For example, when the remaining amount of the liquid L stored in the liquid storage container C is low, a form of a mist where the liquid is mixed with air is likely to occur because both the liquid L and air are supplied from the liquid storage container C to the siphon tube 210.

According to the coupling device 100 of the present embodiment, the stopper (flow channel part) 40 is formed of a conductive fluororesin material and is in electrical conduction with the grounding part 60 maintained at the ground potential. Thus, the static electricity charged on the bellows part 30 or the member nearby such as the stopper 40 is removed by the grounding part 60 via the stopper 40 formed of the conductive fluororesin material. In such a way, according to the coupling device 100 of the present embodiment, it is possible to suitably protect the bellows part 30 having the expandable internal flow channel 31 formed therein from having dielectric breakdown.

According to the coupling device 100 of the present embodiment, by inserting the pin member 62 in the through hole 11 of the housing part 10 to come into contact with the stopper 40, it is possible to cause the stopper 40 to have electrical conduction with the grounding part 60 to suitably remove static electricity charged on the bellows part 30 or the member nearby such as the stopper 40.

### Modified Example

Although the stopper 40 is formed of a conductive fluororesin material and is in electrical conduction with the grounding part 60 maintained at the ground potential in the above description, other forms may be employed. For example, a modified example may be employed in which the bellows part 30 is formed of a conductive fluororesin material and is in electrical conduction with the grounding part 60 maintained at the ground potential.

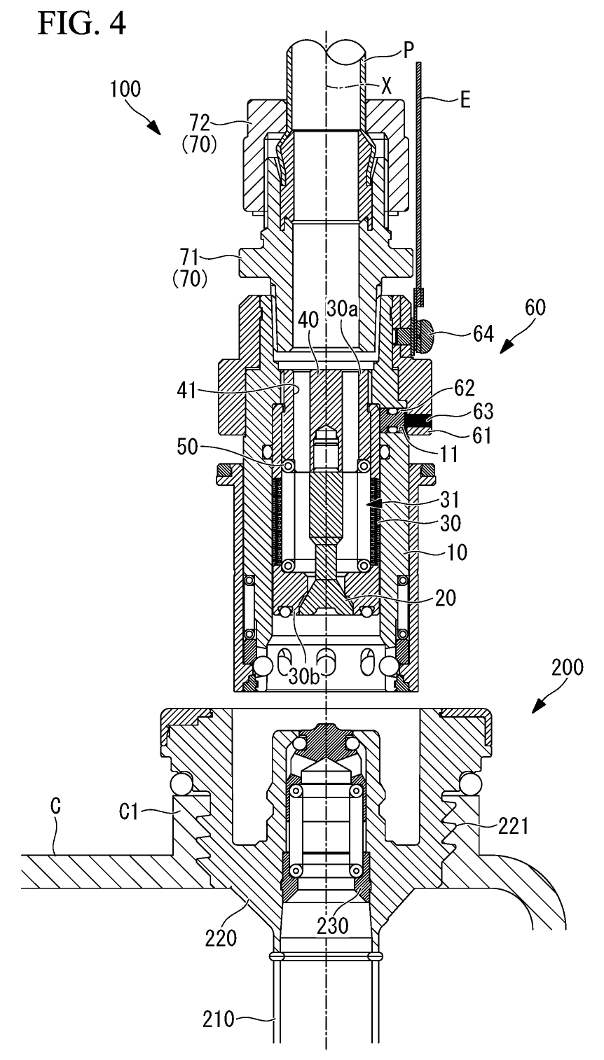

FIG. 4 is a longitudinal sectional view illustrating a modified example of the coupling device 100 illustrated in FIG. 3. In the coupling device 100 illustrated in FIG. 4, the bellows part 30 is formed of a conductive fluororesin material and is in electrical conduction with the grounding part 60 maintained at the ground potential. On the other hand, the stopper 40 is formed of a nonconductive fluororesin material and is not in electrical conduction with the grounding part 60 maintained at the ground potential.

In the present modified example, the pin member 62 is arranged in contact with the bellows part 30 by being pushed against the outer circumferential face of the bellows part 30 by the tip of the fixing screw 63.

According to the coupling device 100 of the present modified example, the bellows part 30 is formed of a conductive fluororesin material and is in electrical conduction with the grounding part 60 maintained at the ground potential. Thus, static electricity charged on the bellows part 30 is removed by the grounding part 60 in electrical conduction with the bellows part 30. In such a way, according to the coupling device 100 of the present embodiment, it is possible to suitably protect the bellows part 30 having the expandable internal flow channel 31 formed therein from having dielectric breakdown.

According to the coupling device 100 of the present modified example, by inserting the conductive member in the through hole of the housing part to come into contact with the bellows part, it is possible to cause the bellows part to have electrical conduction with the grounding part to suitably remove static electricity charged on the bellows part or the member nearby.

### Second Embodiment

A coupling device 100A according to a second embodiment of the present disclosure will be described below with reference to the drawings. Since the present embodiment is a modified example to the first embodiment, the description thereof will be omitted below as being the same as the first embodiment except where specifically described below.

In the coupling device 100 of the first embodiment, the liquid L supplied vertically from below to above from the plug device 200 is guided to the supply pipe P. In contrast, in the coupling device 100A of the present embodiment, a liquid supplied horizontally from a plug device 200A is guided to a supply pipe 300A.

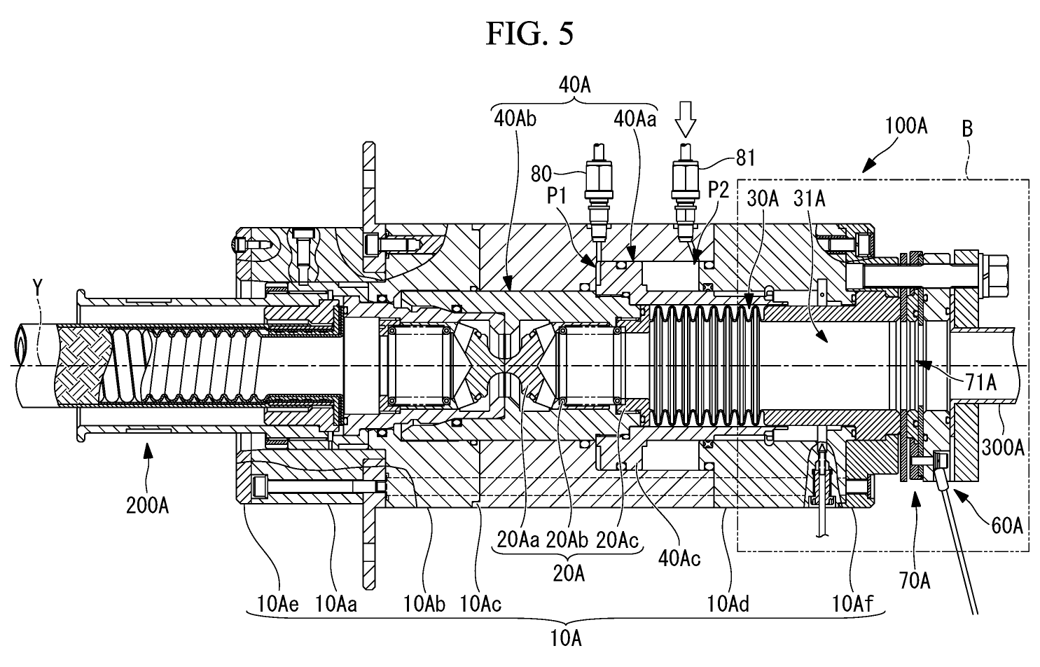

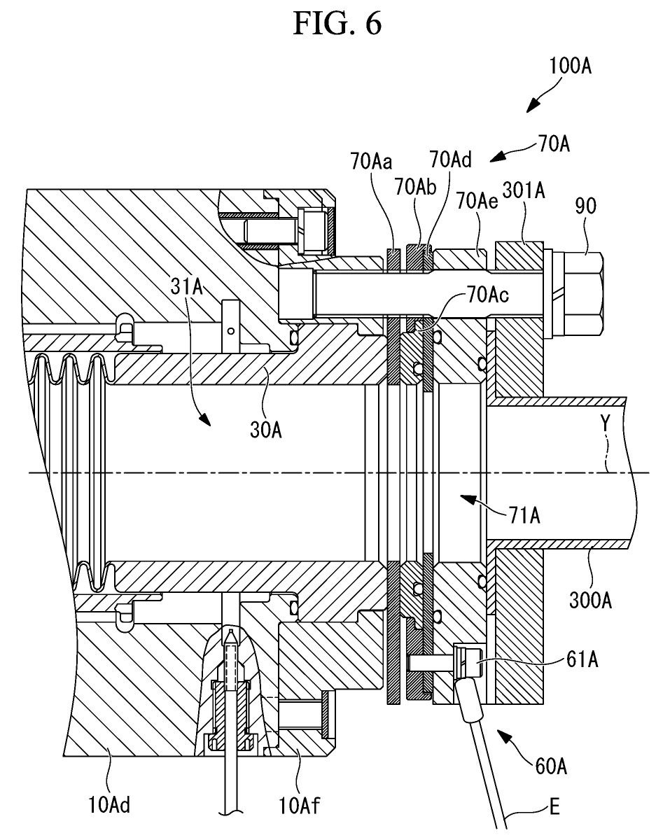

FIG. 5 is a longitudinal sectional view illustrating the coupling device 100A according to the second embodiment of the present disclosure. FIG. 6 is a partial enlarged view of the part B of the coupling device 100A illustrated in FIG. 5. As illustrated in FIG. 5, the coupling device 100A includes a housing part 10A, a valve part 20A, a bellows part 30A, a motion part 40A, a grounding part 60A, and a pipe connecting part 70A.

The housing part 10 is a member formed in a cylindrical shape extending along an axis Y in which the plug device 200A is inserted in one end side of the coupling device 100A arranged along the axis Y and the supply pipe 300A is connected to the other end side of the coupling device 100A arranged along the axis Y. The axis Y is an axis extending in the horizontal direction. The housing part 10A is formed cylindrically along the axis Y and includes a first housing part 10Aa, a second housing part 10Ab, a third housing part 10Ac, and a fourth housing part 10Ad.

A front cover 10Ae is arranged on one end side of the first housing part 10Aa, and a back cover 10Af is arranged on the other end side of the fourth housing part 10Ad. The first housing part 10Aa, the second housing part 10Ab, the third housing part 10Ac, and the fourth housing part 10Ad are integrally coupled to each other and define a cylindrical flow channel therein through which a liquid flows.

Due to contact with the plug device 200A, the valve part 20A is in an open state where a liquid flows into the housing part 10A from the plug device 200A. The valve part 20A includes a valve body 20Aa, a spring 20Ab, and a stopper 20Ac. The outer circumferential face of the valve body 20Aa has a circular cylindrical shape extending along the axis Y and has a slightly smaller outer diameter than the inner circumferential face of a valve part holder 40Ab described later. Therefore, the valve body 20Aa is inserted in the internal space of the valve part holder 40Ab and, in this state, is movable along the axis Y.

The stopper 20Ac is a member formed in a circular annular shape extending about the axis Y and is fixed to the valve part holder 40Ab by the external thread formed on the outer circumferential face being fastened to the internal thread formed in the inner circumferential face of the valve part holder 40Ab. The stopper 20Ac holds the spring 20Ab extending along the axis Y between the valve body 20Aa and the stopper 20Ac. The valve body 20Aa is pushed against the inner circumferential face of the valve part holder 40Ab by pushing force generated by the expanding spring 2Ab and defines an endless seal region extending about the axis Y between the valve part holder 40Ab and the valve body 20Aa.

The bellows part 30A is a member having an expandable internal flow channel 31A formed therein through which a liquid flowing in from the plug device 200A is supplied to the supply pipe 300A. The bellows part 30A is arranged downstream in the liquid flow direction from the valve part 20A inside the housing part 10A.

The motion part 40A is a member that is movable along the axis Y so as to come into contact with or be spaced apart from the plug device 200A, is formed cylindrically along the axis X, and accommodates the valve part 20A and the bellows part 30A therein. The motion part 40A includes the valve part holder 40Ab and a bellows holder 40Aa. The external thread on the valve part holder 40Ab and the internal thread in the bellows holder 40Aa are fastened to each other, and thereby the valve part holder 40Ab and the bellows holder 40Aa are integrated.

A circular annular protruding part 40Ac formed in a circular annular shape extending along the axis Y is formed to the outer circumferential portion of the end of the bellows holder 40Aa. This circular annular protruding part 40Ac is arranged in a circular cylindrical space defined between the third housing part 10Ac and the fourth housing part 10Ad so as to partition this space into a first pressure chamber P1 and a second pressure chamber P2.

The first pressure chamber P1 generates pushing force that moves the circular annular protruding part 40Ac along the axis Y in response to compressed air being supplied via an intake/exhaust port 80. This pushing force is pushing force applied in a direction in which the bellows part 30A is contracted. The second pressure chamber P2 generates pushing force that moves the circular annular protruding part 40Ac along the axis Y in response to compressed air being supplied via an intake/exhaust port 81. This pushing force is pushing force applied in a direction in which the bellows part 30A is expanded.

The pipe connecting part (flow channel part) 70A is a member that defines a supply flow channel 71A through which a liquid is supplied from the internal flow channel 31A to the supply pipe 300A. As illustrated in FIG. 6, the pipe connecting part 70A has a packing 70Aa, a conduction plate 70Ab, an annular member 70Ac, a conductive sheet 70Ad, and an annular member 70Ae. The fastening bolt 90 is fastened to the back cover 10Af, and thereby the pipe connecting part 70A is fixed interposed between the back cover 10Af and an attaching flange 301A.

The conductive sheet 70Ad is formed of a conductive fluororesin material containing a fluororesin material and a conductive material dispersed in the fluororesin material. The packing 70Aa, the annular member 70Ac, and the annular member 70Ae are formed of a nonconductive fluororesin material in which no conductive material is dispersed. The conduction plate 70Ab is formed of a metal material. The conductive sheet 70Ad is a plate-like member formed in a circular annular shape so as to surround the axis Y, and the end thereof on the inner circumferential side contacts with a liquid flowing through the supply flow channel 71A.

The grounding part 60A is a member arranged to have electrical conduction with the conductive sheet 70Ad and maintained at the ground potential by being coupled to the grounding cable E. The grounding part 60A has an attaching screw 61A formed of a conductive material (for example, a stainless-steel material). The attaching screw 61A is fastened to a fastening hole formed in the conduction plate 70Ab. The conductive sheet 70Ad is arranged in contact with the conduction plate 70Ab and maintained at the ground potential.

The effects and advantages achieved by the coupling device 100A of the present embodiment described above will be described.

According to the coupling device 100A of the present embodiment, when the plug device 200A is inserted in one end side of the housing part 10A, the valve part 20A is in an open state, and a liquid flows into the coupling device 100A. The liquid that has flown into the housing part 10A is supplied from the bellows part 30A, which has the expandable internal flow channel 31A formed therein, to the supply pipe 300A, which is connected to the other end side of the housing part 10A, via the supply flow channel 71A defined by the pipe connecting part 70A.

When a liquid flows from the plug device 200A to the supply pipe P via the coupling device 100A, electrostatic charge may occur on the bellows part 30A or the member nearby due to friction between the internal flow channel 31A and the liquid. In particular, when the liquid supplied from the plug device 200A to the coupling device 100A is in a form of a mist mixed with air, the occurrence of electrostatic charge on the bellows part 30A or the member nearby is notable.

According to the coupling device 100A of the present embodiment, the conductive sheet (flow channel part) 70Ad is formed of a conductive fluororesin material and is in electrical conduction with the grounding part 60A maintained at the ground potential. Thus, the static electricity charged on the bellows part 30A or the member nearby is removed by the grounding part 60A via the conductive sheet 70Ad formed of the conductive fluororesin material. In such a way, according to the coupling device 100A of the present embodiment, it is possible to suitably protect the bellows part 30A having the expandable internal flow channel 31A formed therein from having dielectric breakdown.

### First Modified Example

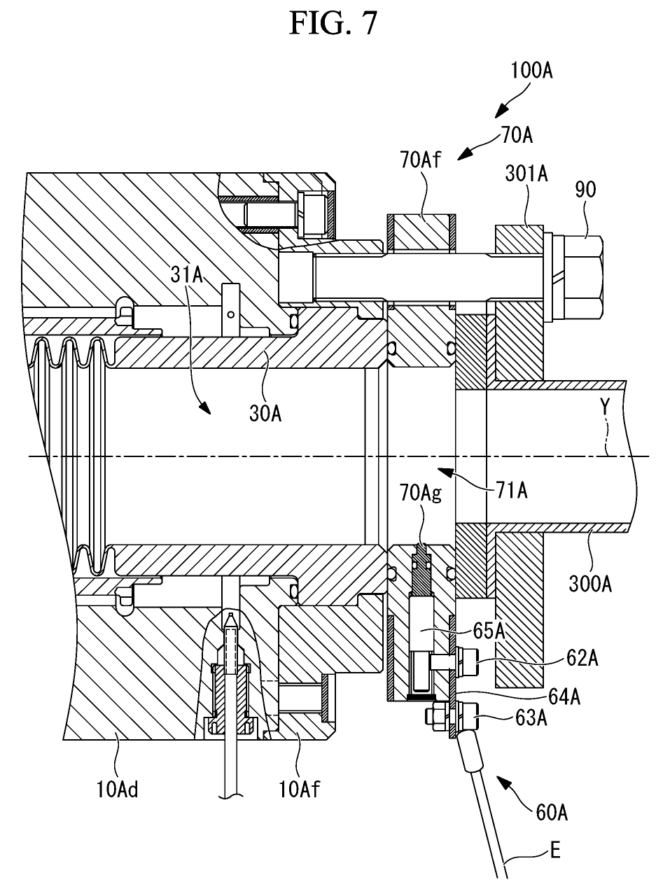

Although the conductive sheet 70Ad of the pipe connecting part 70A is caused to be in contact with a liquid flowing through the supply flow channel 71A, the conductive sheet 70Ad is maintained at the ground potential through the grounding part 60A, and thereby static electricity charged on the bellows part 30A or the member nearby is removed in the above description, other forms may be employed. For example, the coupling device 100A of a first modified example illustrated in FIG. 7 may be employed.

The first modified example is to remove static electricity charged on the bellows part 30A or the member nearby by causing a pin member 70Ag of the pipe connecting part 70A to be in contact with a liquid flowing through the supply flow channel 71A and maintaining the pin member 70Ag at the ground potential through the grounding part 60A. As illustrated in FIG. 7, the pipe connecting part 70A of the first modified example has an annular member 70Af and a pin member 70Ag.

The annular member 70Af is a member formed annularly so as to surround the axis Y and formed of a nonconductive fluororesin material in which no conductive material is dispersed. A through hole in which the pin member 70Ag is inserted is formed in the annular member 70Af. The pin member 70Ag is a member inserted in the through hole formed in the annular member 70Af and is formed of a conductive fluororesin material in which a conductive material is dispersed. The tip of the pin member 70Ag is inserted in the through hole and, in this state, is in contact with a liquid flowing through the supply flow channel 71A.

The annular member 70Af may have the through hole for insertion of the pin member 70Ag at a single position illustrated in FIG. 7 or may have such through holes at multiple positions circumferentially about the axis Y (for example, three positions with intervals of 120 degrees). When the annular member 70Af has through holes at multiple positions, each pin member 70Ag is inserted in each through hole. These pin members 70Ag are attached to have electrical conduction with the grounding part 60A, respectively.

The grounding part 60A is a member arranged to have electrical conduction with the pin member 70Ag and maintained at the ground potential by being coupled to the grounding cable E. The grounding part 60A has an attaching screw 62A, a fixing screw 63A, a conductive plate 64A, and a conduction material 65A formed of a conductive material (for example, a stainless-steel material), respectively.

The attaching screw 62A is fastened to a fastening hole formed in the annular member 70Af. The fixing screw 63A is attached to the conductive plate 64A and fixes the grounding cable E to the conductive plate 64A in an electrically conductive state. The conduction material 65A is attached to a through hole formed in the annular member 70Af in contact with the pin member 70Ag. The pin member 70Ag is arranged in contact with the conduction material 65A, is in electrical conduction with the grounding cable E via the attaching screw 62A, and thereby is maintained at the ground potential.

According to the coupling device 100A of the present modified example, the pin member (flow channel part) 70Ag is formed of a conductive fluororesin material and is in electrical conduction with the grounding part 60A maintained at the ground potential. Thus, the static electricity charged on the bellows part 30A or the member nearby is removed by the grounding part 60A via the pin member 70Ag formed of the conductive fluororesin material. In such a way, according to the coupling device 100A of the present embodiment, it is possible to suitably protect the bellows part 30A having the expandable internal flow channel 31A formed therein from having dielectric breakdown.

### Second Modified Example

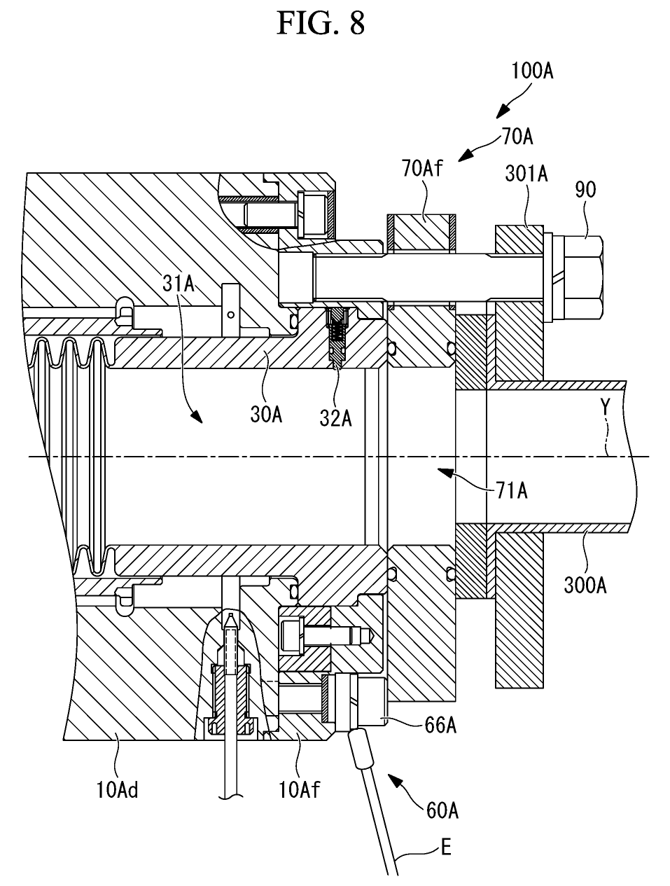

Although the pin member 70Ag formed of the conductive fluororesin material is inserted in the through hole formed in the annular member 70Af of the pipe connecting part 70A to be in contact with a liquid flowing through the supply flow channel 71A in the first modified example, other forms may be employed. For example, the coupling device 100A of a second modified example illustrated in FIG. 8 may be employed.

In the coupling device 100A of the second modified example, a pin member 32A is inserted in a through hole formed in the bellows part 30A. The pin member 32A is a member inserted in the through hole formed in the bellows part 30A and is formed of a conductive fluororesin material in which a conductive material is dispersed. The tip of the pin member 32A is inserted in the through hole and, in this state, is in contact with a liquid flowing through the internal flow channel 31A. The pin member 32A is arranged in contact with the back cover 10Af formed of a conductive metal material (for example, a stainless-steel material).

The bellows part 30A may have the through hole for insertion of the pin member 32A at a single position illustrated in FIG. 8 or may have such through holes at multiple positions circumferentially about the axis Y (for example, three positions with intervals of 120 degrees). When the bellows part 30A has through holes at multiple positions, each pin member 32A is inserted in each through hole. These pin members 32A are attached to have electrical conduction with the grounding part 60A, respectively.

The grounding part 60A is a member arranged to have electrical conduction with the back cover 10Af and maintained at the ground potential by being coupled to the grounding cable E. The grounding part 60A has an attaching screw 66A formed of a conductive material (for example, a stainless-steel material). The attaching screw 66A is fastened to a fastening hole formed in the back cover 10Af. The pin member 32A is arranged in contact with the back cover 10Af and maintained at the ground potential.

According to the coupling device 100A of the present modified example, the pin member (flow channel part) 70Ag is formed of a conductive fluororesin material and is in electrical conduction with the grounding part 60A maintained at the ground potential. Thus, the static electricity charged on the bellows part 30A or the member nearby is removed by the grounding part 60A via the pin member 70Ag formed of the conductive fluororesin material. In such a way, according to the coupling device 100A of the present embodiment, it is possible to suitably protect the bellows part 30A having the expandable internal flow channel 31A formed therein from having dielectric breakdown.

### Third Modified Example

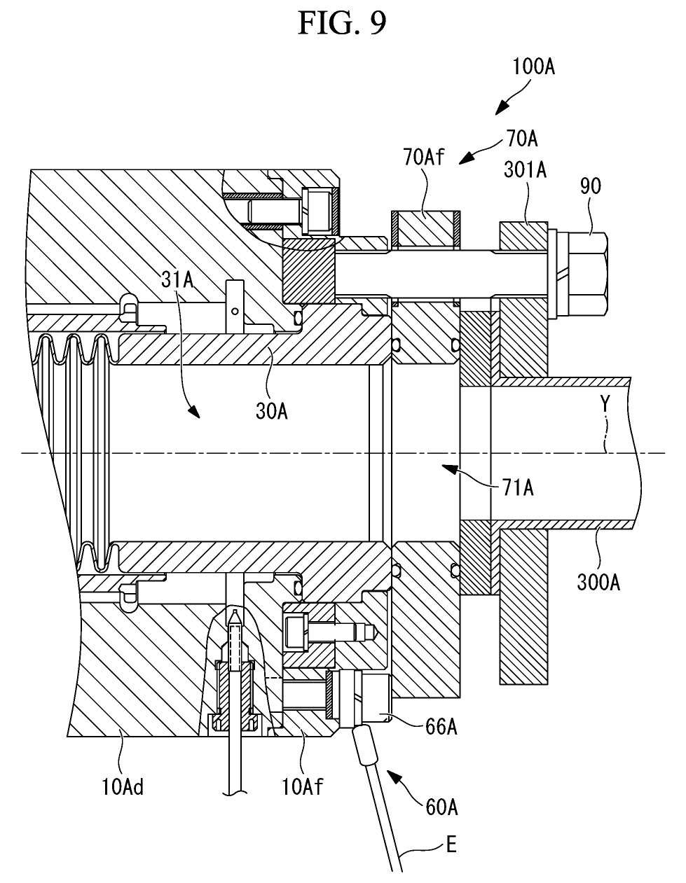

Although the pin member 32A formed of a conductive fluororesin material is inserted in the through hole formed in the bellows part 30A to be in contact with a liquid flowing through the internal flow channel 31A in the second modified example, other forms may be employed. For example, as illustrated in FIG. 9, the coupling device 100A of the third modified example may be employed in which the bellows part 30A is formed of a conductive fluororesin material and is in electrical conduction with the grounding part 60A maintained at the ground potential.

In the coupling device 100A of the third modified example, the bellows part 30A is formed of a conductive fluororesin material. The bellows part 30A is arranged in contact with the back cover 10Af formed of a conductive metal material (for example, a stainless-steel material).

The grounding part 60A is a member arranged to have electrical conduction with the back cover 10Af and maintained at the ground potential by being coupled to the grounding cable E. The grounding part 60A has an attaching screw 66A formed of a conductive material (for example, a stainless-steel material). The attaching screw 66A is fastened to a fastening hole formed in the back cover 10Af. The bellows part 30A is arranged in contact with the back cover 10Af and maintained at the ground potential.

According to the coupling device 100A of the present modified example, the bellows part 30A is formed of a conductive fluororesin material and is in electrical conduction with the grounding part 60A maintained at the ground potential. Thus, the static electricity charged on the bellows part 30A or the member nearby is removed by the grounding part 60A. In such a way, according to the coupling device 100A of the present embodiment, it is possible to suitably protect the bellows part 30A having the expandable internal flow channel 31A formed therein from having dielectric breakdown.

### Fourth Modified Example

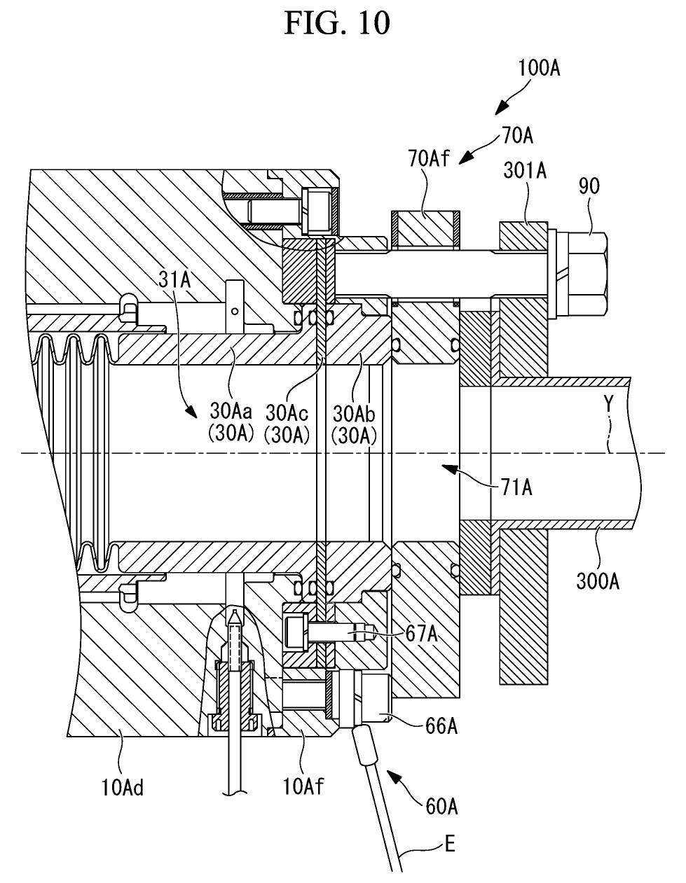

Although the entire bellows part 30A is formed of a conductive fluororesin material in the coupling device 100A of the third modified example, other forms may be employed. For example, as with a coupling device 100A of the fourth modified example illustrated in FIG. 10, a part of the bellows part 30A may be formed of a conductive fluororesin material, and the remaining part may be formed of a nonconductive fluororesin material.

As illustrated in FIG. 10, the bellows part 30A of the fourth modified example has a first member 30Aa, a second member 30Ab, and a third member 30Ac. The first member 30Aa and the second member 30Ab are formed of a nonconductive fluororesin material, respectively. On the other hand, the third member 30Ac is a member formed annularly about the axis Y and in a plate-like manner and is formed of a conductive fluororesin material. The third member 30Ac is arranged interposed between the first member 30Aa and the second member 30Ab such that the end on the inner circumferential side contacts with a liquid flowing through the supply flow channel 71A.

The grounding part 60A is a member arranged to have electrical conduction with the third member 30Ac and maintained at the ground potential by being coupled to the grounding cable E. The grounding part 60A has an attaching screw 66A and an attaching screw 67A formed of a conductive material (for example, a stainless-steel material). The attaching screw 66A and the attaching screw 67A are fastened to fastening holes formed in the back cover 10Af. The third member 30Ac is arranged in contact with the attaching screw 67A and maintained at the ground potential via the back cover 10Af and the attaching screw 66A.

What is claimed is:

1. A coupling device for coupling a plug device and a supply pipe to each other, the plug device being for supplying a liquid, and the supply pipe being for supplying the liquid to a supply target, the coupling device comprising:
a cylindrical housing part, the plug device being inserted in one end side of the housing part, and the supply pipe being connected to the other end side of the housing part;
a valve part configured to, due to contact with the plug device inserted in the housing part, be in an open state where the liquid flows into the coupling device from the plug device;
a bellows part having an expandable internal flow channel formed in the bellows part, the liquid flowing in from the plug device being supplied to the supply pipe through the expandable internal flow channel when the valve part is in the open state; and
a flow channel part forming a supply flow channel, the liquid being supplied from the internal flow channel to the supply pipe through the supply flow channel,
wherein one of the bellows part and the flow channel part is formed of a conductive fluororesin material, the conductive fluororesin material containing a fluororesin material and a conductive material dispersed in the fluororesin material, and is in electrical conduction with a grounding part maintained at a ground potential.

2. The coupling device according to claim 1, wherein the flow channel part is formed of the conductive fluororesin material and is in electrical conduction with the grounding part.

3. The coupling device according to claim 2,
wherein the flow channel part is formed in a cylindrical shape and fixed to an inner circumferential face of the housing part,
wherein the housing part has a through hole passing through between the inner circumferential face and an outer circumferential face of the housing part toward the flow channel part, and
wherein the grounding part has a conductive member inserted in the through hole and arranged in contact with the flow channel part.

4. The coupling device according to claim 2, wherein the flow channel part is a plate-like member formed in a circular annular shape so as to surround an axis, the supply flow channel extending along the axis.

5. The coupling device according to claim 1, wherein the bellows part is formed of the conductive fluororesin material and is in electrical conduction with the grounding part.

6. The coupling device according to claim 5,
wherein the housing part has a through hole passing through between an inner circumferential face and an outer circumferential face of the housing part toward the bellows part, and
wherein the grounding part has a conductive member inserted in the through hole and arranged in contact with the bellows part.
